(19) United States
(12) Patent Application Publication
(10) Pub. No.: US 2012/0299406 A1
(43) Pub. Date: Nov. 29, 2012

(54) WASHING MACHINE

(76) Inventors: Sang Wook Hong, Seoul (KR); Dong Won Kim, Seoul (KR); Na Eun Kim, Seoul (KR)

(21) Appl. No.: 13/576,691

(22) PCT Filed: Jan. 18, 2011
(86) PCT No.: PCT/KR11/00355

§ 371 Date: Aug. 2, 2012

(30) Foreign Application Priority Data
Feb. 2, 2010 (KR) 10-2010-0009525

(51) Int. Cl. H02K 9/06

(52) U.S. Cl. 310/62

(57) ABSTRACT

A washing machine is disclosed. An object of the present invention is to provide a washing machine which can radiate the heat generated from the stator outside, regardless of a rotational direction of a rotor.

### TECHNICAL FIELD

The present invention relates to a washing machine.

### BACKGROUND ART

A conventional drum type washing machine includes a cabinet configured to define an exterior appearance thereof, a tub installed in the cabinet to hold wash water and a drum rotatably provided in the tub to receive laundry items therein.

The drum is rotated by a motor and vibration generated during the rotation of the drum is transmitted to the tub. Since the tub is fixed to the cabinet via a spring and a damper, the vibration generated by the rotation of the drum is structured not to be transmitted to the cabinet.

In the meanwhile, the motor is provided in an outer rear surface of the tub, with being connected with a rear surface of the drum located inside the tub. This structure of the motor rotates the drum.

The motor is configured of a stator and a rotor. A plurality of heat-radiating holes may be formed in the rotor to radiate heat generated from the stator and a plurality of blades may be formed in the rotor to guide air toward the heat radiating holes.

The heat radiating holes and the blades of the rotor have not to interfere with the stator, while the rotor is rotated. Because of that, it is not easy to change the structure of the heat radiating holes and the blades to enhance heat radiating efficiency.

### DISCLOSURE OF INVENTION

### Technical Problem

To solve the problems, an object of the present invention is to provide a washing machine which can radiate heat generated from a stator smoothly and efficiently.

Another object of the present invention is to provide a washing machine which can radiate the heat generated from the stator outside, regardless of a rotational direction of a rotor.

### Technical Solution

To achieve these objects and other advantages and in accordance with the purpose of the invention, as embodied and broadly described herein, a washing machine includes a cabinet configured to define an exterior appearance thereof; a tub installed in the cabinet to store wash water therein; a drum rotatably provided in the tub to receive laundry therein; a motor assembly comprising a rotor rotatably secured to an outside of the tub; a stator provided in the rotor, the stator fixed to a rear surface of the tub; and a shaft passing through the tub to connect the rotor with the drum, wherein the rotor comprises a heat radiating hole configured to allow air to pass there through and a blade configured to guide air toward the heat radiating hole, and the size of the heat radiating hole is larger than the size of the blade.

In this case, the rotor may include a base formed in a circular shape and a side wall provided in an outer circumferential surface of the base, and the heat radiating hole may be provided along a circumferential direction of the base.

Also, the blade may be formed by perforating and bending the base (or the base may be perforated and bent only to form the blade), and the heat radiating hole may be a predetermined space formed by the bent blade.

The heat radiating hole may be formed by perforating the base one more time to allow the width of the blade larger than the width of the heat radiating hole. (or the base may be perforated again only to form the heat radiating hole such that the width of the blade may be larger than the width of the heat radiating hole)

In the meanwhile, a plurality of blades and a plurality of heat radiating holes are provided in the rotor, and a formation direction of the blades may be symmetrical with respect to a virtual central line passing a center of the base.

Also, a formation direction of the blades may be symmetrical with respect to virtual first and second central lines which are perpendicular to each other, passing a center of the base.

The blades may be divided into a suction group configured to suck air into the rotor and an exhaustion group configured to exhaust air out of the rotor.

In this case, the suction group and the exhaustion group may be reversed according to the rotation direction of the rotor.

Also, the number of the heat radiating holes forming the suction group may be identical to the number of the heat radiating holes forming the exhaustion group.

### Advantageous Effects

The present invention has following advantageous effects.

The present invention may provide an effect of providing the washing machine which can radiate heat generated in the stator smoothly and efficiently.

Furthermore, the present invention may provide an effect of providing the washing machine which can radiate the heat generated in the stator outside, regardless of the rotation direction of the rotor.

### Brief Description of the Drawings

The accompanying drawings, which are included to provide further understanding of the disclosure and are incorporated in and constitute a part of this application, illustrate embodiments of the disclosure and together with the description serve to explain the principle of the disclosure.

In the drawings:

FIG. 1 is a sectional view illustrating a washing machine according to an exemplary embodiment of the present invention;

FIG. 2 is a plane view illustrating a rotor according to the present invention;

FIG. 3 is a diagram illustrating a forming process of a blade provided in the rotor;

FIG. 4 is a diagram illustrating a shape of blades arranged in the rotor; and

FIG. 5 is a diagram illustrating another shape of blades arranged in the rotor.

### BEST MODE

As follows, an exemplary embodiment of the present invention will be described in reference to the accompanying drawings.

Only without special definition, terminology used in the specification of the present invention may be identical to general meaning of common terminology understood by people who are skilled in the art the present invention pertains to. If the meaning of the terminology used in the present specification collides with common meaning of terminology used in this art, the definition of the terminology used in the present specification is adapted.

In the meanwhile, reference will now be made in detail to the specific embodiments of the present invention, examples of which are illustrated in the accompanying drawings. Wherever possible, the same reference numbers will be used throughout the drawings to refer to the same or like parts.

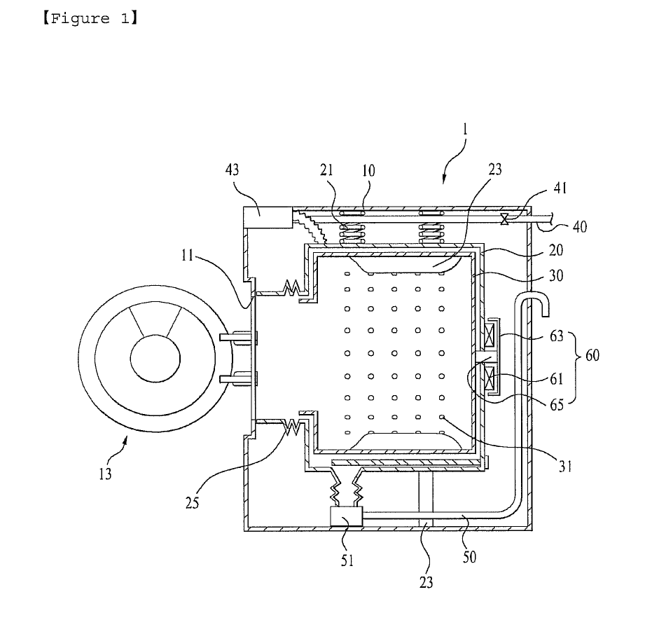

As shown in FIG. 1, a washing machine 1 according to the exemplary embodiment of the present invention includes a cabinet 10 configured to define an exterior appearance thereof, a tub 20 provided in the cabinet to hold wash water therein, and a drum 30 rotatable within the tub.

An introduction opening 11 is provided in a front of the cabinet 10 to load and unload laundry items and the introduction opening 11 is opened and closed by a door 13 coupled to the cabinet.

The tub 20 and the drum 30 which are provided in the cabinet 10 include openings in communication with the introduction opening 11 of the cabinet 10, respectively, such that a user may introduce or take out laundry into or from the drum.

The tub 20 may store wash water supplied via a water supply hose 40 and it may exhaust the wash water used in laundry washing outside via a water drainage hose 50.

A water supply valve 41 may be provided in the water supply hose 40 to allow wash water selectively drawn into the tub from a water supply source provided outside the washing machine. A detergent box 43 may be further provided between the water supply valve and the tub to supply detergent to the tub during the wash water supplying.

A water drainage pump 51 may be provided in the water drainage hose 50 to drain the wash water stored in the tub selectively.

Since the tub 20 is configured to store and exhaust wash water as described above, the wash water might leak into the introduction opening 11 of the cabinet 10. To prevent the wash water leakage, a gasket 25 may be provided between the opening of the tub and the introduction opening of the cabinet.

In the meanwhile, the drum 30 rotate by a motor 60 which will be described later is provided in the tub. Because of that, vibration generated during the rotation of the drum may be transmitted to the tub 20. If the vibration transmitted to the tub is transmitted even to the cabinet, noise and vibration will be generated during the washing. To prevent the vibration from being transmitted to the cabinet, it is preferable that a spring 21 and a damper 23 capable of reducing the vibration transmitted to the tub is provided between the tub and the cabinet.

The motor 60 configured to rotate the drum 30 is provided in an outer rear surface of the tub 20 and the motor includes a stator 61, a rotor 63 and a shaft 65. The stator 61 is fixed to the tub and the rotor 63 is rotated, interacting with the stator. The shaft 65 is fixed to the rotor, with being connected to a rear surface of the drum via the tub.

The stator 61 includes coil and the rotor 63 includes a magnet interacting with a magnetic field induced to the coil.

As a result, when an electric current is supplied to the coil provided in the stator, the rotor 63 is rotated by the interaction between the coil and the magnet and the drum 30 connected with the rotor via the shaft 65 is also rotated.

In the meanwhile, it is preferable that the motor 60 is configured of an outer rotor type, with the stator 61 located in the rotor 63 as shown in FIG. 1.

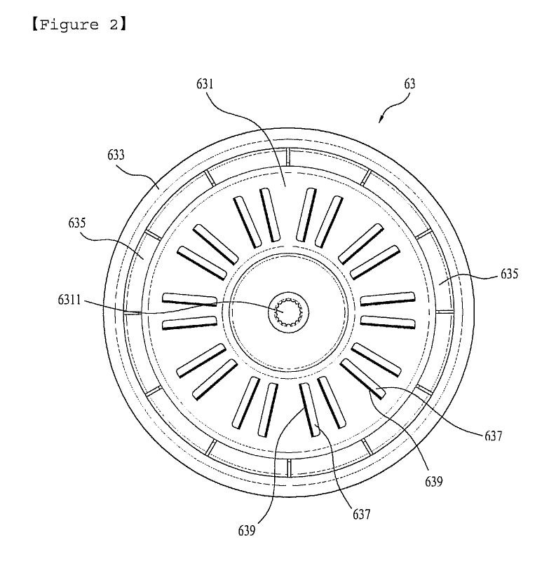

The rotor 63 provided in the motor 60 will be described in detail in reference to FIG. 2. The rotor 63 includes a base 631 having a circular appearance and a side wall 633 curvedly provided in an outer circumferential surface of the base.

A shaft hole 6311 is provided in the base 631 to allow the shaft 65 fixed thereto and a plurality of magnets 635 is provided in the side wall 633.

The size of the base 631 is determined to allow the stator 61 located in a predetermined space defined by both of the base 631 and the side wall 633. In addition, the size of the base 631 is determined enough to allow the plurality of the magnets provided in the side wall to maintain a predetermined interval with respect to the outer circumferential surface of the stator 61.

In case of the motor including only the components mentioned above, the electric current is supplied to the coil provided in the stator to rotate the rotor. If then, high temperature heat is generated in the stator and the performance of the motor happens to deteriorate disadvantageously. Because of that, the rotor provided in the motor according to the present invention has a characteristic of cooling the stator such that it can maintain the performance of the motor.

In other words, a plurality of heat radiating holes 637 and a plurality of blades 639 may be further provided in the base 631 of the motor.

The plurality of the heat radiating holes 637 may be arranged outer to the shaft hole in a radial shape and each of the heat radiating holes 637 has a predetermined length along a radial direction of the base 631.

The plurality of the heat radiating holes 637 may be employed as passage used to suck air guided by the plurality of the blades 639 into the rotor or to exhaust the air guided by the plurality of the blades 639 outside the rotor, while the rotor 63 is rotated.

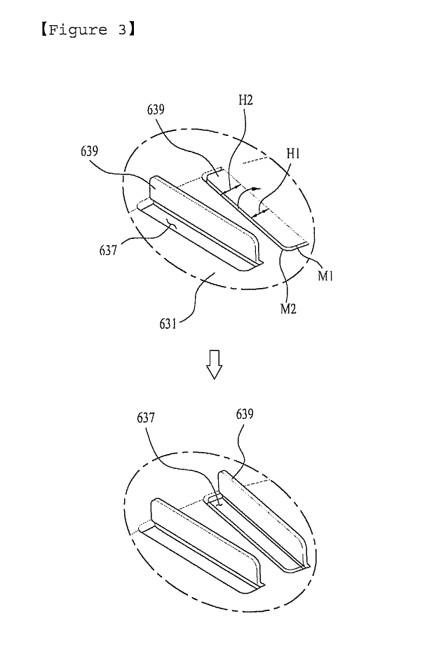

As shown in FIG. 3, the base 631 is perforated in a wished shape (M1). After that, a predetermined portion of the base surrounded by the perforation (M1) is bent to form the blade 639.

In this case, the plurality of the heat radiating holes 637 may be defined as holes formed after the plurality of the blades are bent. It is preferable that the size (H2) of the heat radiating hole 637 is larger than the side (H1) of the blade 639.

The reason why the side (H2) of the heat radiating hole 637 is larger than the size (H1) of the blade 639 is that the amount of the air sucked and exhausted via the plurality of the heat radiating holes 637 is increased in case the size (H2) of the heat radiating hole 637 is increased. If the amount of the air is increased, the heat generated in the stator 61 can be cooled more effectively.

For that, it is preferable that an outer circumferential surface of the perforation (M1) configured to form the blade is perforated again (M2) and that the plurality of the heat radiating holes 637 are provided by the second perforation (M2).

In the meanwhile, the method of the perforation configured to form the plurality of the blades and the plurality of the heat radiating holes may be performed by a lancing process which cuts the base or a punching process which forms a hole having a wished shape in the base.

In other words, lancing (M1 or punching) configured to form the plurality of the blades in the base 631 and heat radiating hole lancing (M2 or punching) performed along an outer circumferential surface of the blade lancing process (M1). After that, the plurality of the blades 639 are bent from the base 631 only to form the plurality of the heat radiating holes and the plurality of the blades.

When the heat radiating hole lancing (M2) is performed along the outer circumferential surface of the blade lancing (M1), the size (H2) of the heat radiating hole is larger than the size (H1) of the blade naturally. Because of that, the amount of the air sucked into and exhausted from the rotor 63 during the rotation of the rotor 63 may be increased and the heat generated in the stator 61 may be then cooled more effectively.

As follows, the arrangement of the plurality of the blades and the plurality of the heat radiating holes will be described.

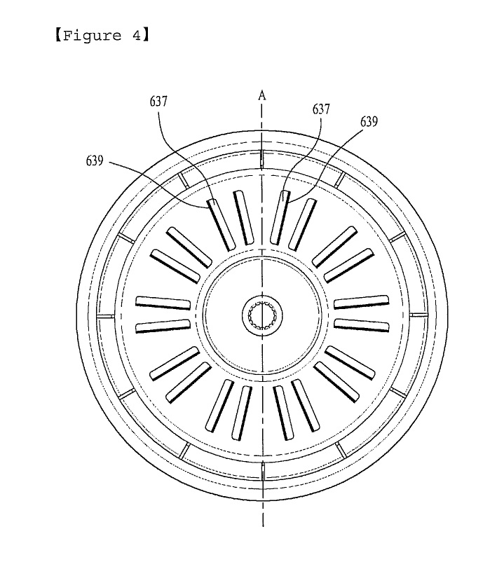

As shown in FIG. 4, the rotor 63 according to the exemplary embodiment of the present invention includes the plurality of the heat radiating holes 637 and the plurality of the blades 639. Here, the heat radiating holes 637 and the blades 639 may be symmetric with respect to a central line (A) passing a center of the base 631.

In other words, a predetermined number of heat radiating holes 637 and blades 639 located in a left side with respect to the central line (A) are symmetric to the other heat radiating holes 637 and blades 639 located in a right side with respect to the central line (A).

In this case, the blades 639 located in the left side of the central line (A) may be located in a left side of the heat radiating holes 637. The blades 639 located in the right side of the central line (A) may be located in a right side of the heat radiating holes 637.

This is because the heat radiating holes have to be divided into a suction group and an exhaustion group.

As follows, the suction group of the heat radiating holes and the exhaustion group of the heat radiating holes will be described, according to cases of dividing the blades into the blades bent toward the inside of the rotor and the blades bent toward the outside of the rotor.

When the rotor 63 is rotated in a clockwise direction in case the blades are bent toward the inside of the rotor (bent forwardly, seen in the drawings), internal air of the rotor 63 collides with the blades 639 formed in the left side of the central line (A) only to be guided toward the neighboring heat radiating holes 637. Because of that, the heat radiating holes 637 formed in the left side of the central line (A) may be the exhaustion group.

In contrast, the blades formed in the right side of the central line (A) shut off the internal air of the rotor from being exhausted outside the rotor. Because of that, the heat radiating holes 637 formed in the right side of the central line (A) may be the suction group.

However, when the rotor 63 is rotated in a counter-clockwise direction in case the blades are bent toward the inside of the rotor, the internal air of the rotor 63 may be exhausted outside the rotor via the heat radiating holes 637 formed in the right side of the central line (A) and external air may be sucked into the rotor via the heat radiating holes 637 formed in the left side of the central line (A).

In the meanwhile, when the rotor 63 is rotated in the clockwise direction in case the blades are bent toward the outside of the rotor (bent rearward, seen on the drawings), external air collides with the blades formed in the left side of the central line (A) only to be guided toward the heat radiating holes 637. Because of that, the heat radiating holes 637 formed in the left side of the central line (A) may be the suction group.

In this case, the blades 639 formed in the right side of the central line (A) shut off the suction of the air. Because of that, the heat radiating holes formed in the right side of the central line (A) may be the exhaustion group.

However, when the rotor 63 is rotated in the counter-clockwise direction in case the blades are bent toward the outside of the rotor 63, air may be sucked via the heat radiating holes 637 formed in the right side of the central line (A) and the air may be exhausted via the heat radiating holes 637 formed in the left side of the central line (A).

As a result, when the heat radiating holes and the blades are symmetrical with respect to the central line (A), it may be possible to exhaust the internal air of the rotor and to suck the external air of the rotor, even with any rotation direction of the rotor.

In this case, the number of the suction group and the number of the exhaustion group may be a half of the entire number of the heat radiating holes 637.

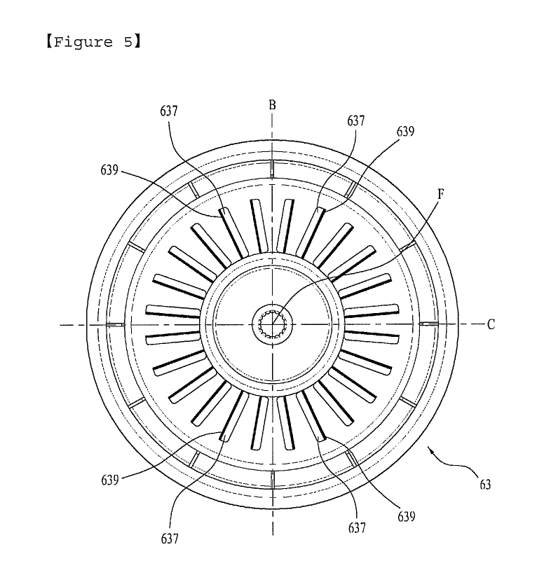

In the meanwhile, as shown in FIG. 5, a rotor 63 according to another embodiment of the present invention includes a plurality of heat radiating holes 637 and a plurality of blades 639, which have symmetrical shapes with respect to a virtual first central line (B) and a virtual second central line (C) passing a center of the base 631.

That is, there may be symmetry between heat radiating holes 637 and blades 639 located in a left side of the first central line (B) and heat radiating holes 637 and blades 639 located in a right side of first central line (B). At the same time, there may be symmetry between heat radiating holes 637 and blades 639 located in a left side of the second central line (C) and heat radiating holes 637 and blades 639 located in a right side of the second central line (C).

In FIG. 5, a right upper portion with respect to the first central line (B) is referenced to as ‘first quadrant’ and a left upper portion with respect to the first central line (B) is referenced to as ‘second quadrant’. A left lower portion with respect to the first central line (B) is referenced to as ‘third quadrant’ and a right lower portion with respect to the first central line (B) is referenced to as ‘fourth quadrant’. According to this definition, arrangement of the heat radiating holes and blades will be described as follows.

The blades 639 are located in a left side of the heat radiating holes in the second quadrant with respect to an intersection point (F) of the first central line (B) and second central line (C). The blades 639 are located in a right side of the heat radiating holes 637 in the first quadrant with respect to the intersection point (F). At the same time, the blades 639 are located in a right side of the heat radiating holes 637 in the third quadrant with respect to the intersection point (F) and the blades 639 are located in a left side of the heat radiating holes 637 in the fourth quadrant with respect to the intersection point (F).

When the rotor 63 is rotated in a clockwise direction in case the blades are bent toward the inside of the rotor (bent forwardly seen in the drawing), internal air of the rotor 63 may collide with the blades located in the second and fourth quadrants only to be guided toward the heat radiating holes 637. Because of that, the heat radiating holes located in the second and fourth quadrants may be the exhaustion group. The heat radiating holes 637 located in the other first and third quadrants may be the suction group.

In contrast, when the rotor 63 is rotated in a counter-clockwise direction, the internal air of the rotor 63 may collide with the blades 639 located in the first and third quadrants and the air may be then guided toward the heat radiating holes 637. Because of that, the heat radiating holes 637 located in the first and third quadrants may be the exhaustion group and the heat radiating holes 637 located in the other second and fourth quadrants may be the suction group.

However, when the rotor 63 is rotated in the clockwise direction in case the blades are bent toward the outside of the rotor 63 (bent rearward, seen in the drawing), external air of the rotor 63 may collide with the blades 639 located in the second and fourth quadrants and the air may be then guided toward the heat radiating holes 637. Because of that, air may be sucked via the heat radiating holes 637 located in the second and fourth quadrants and the air may be exhausted via the heat radiating holes 637 located in the third and third quadrants.

In contrast, when the rotor 63 is rotated in a counter-clockwise direction with the blades 639 bent toward the outside of the rotor, the external air of the rotor may be sucked via the heat radiating holes 639 located in the third and third quadrants and the internal air of the rotor 63 may be exhausted via the heat radiating holes located in the second and fourth quadrants.

As a result, the half of the heat radiating holes 637 with respect to the first central line (B) and the second central line (C) may always suck the air and the other half may always exhaust the air.

In other words, the heat radiating holes 637 may be divided into the suction group configured to suck air there through and the exhaustion group configured to exhaust air there through. The suction group and the exhaustion group may be reversed, based on the rotation of the rotor 63.

In this case, it is preferable that the number of the heat radiating holes forming the suction group and the number of the heat radiating holes forming the exhaustion group is a half of the entire number of the heat radiating holes 637 (the number of the heat radiating holes forming the suction group is identical to that of the heat radiating holes forming the exhaustion group).

According to the present invention having the characteristics described above, a predetermined amount of heat radiation air (50%) may be secured even when the rotor is rotated in any direction. As a result, heat radiation efficiency of the stator may be enhanced advantageously.

Furthermore, the size of the heat radiating hole may be larger than the size of the blade. As a result, the size of the heat radiating hole may be increased in comparison to the size of the conventional heat radiating hole according to the related art. Because of that, the air suction and exhaustion may be smooth and efficient and there may be an effect of improved heat radiation efficiency.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A washing machine comprising:
a cabinet configured to define an exterior appearance thereof;
a tub installed in the cabinet to store wash water therein;
a drum rotatably provided in the tub to receive laundry therein;
a motor assembly comprising a stator fixed to a rear surface of the tub, a rotor provided outside of the tub to interact with the stator and a shaft connecting the rotor with the drum,
wherein the rotor comprises a heat radiating hole configured to allow air to pass therethrough and a blade configured to guide air toward the heat radiating hole, and the size of the heat radiating hole is larger than the size of the blade.

2. The washing machine as claimed in claim 1, wherein the rotor comprises a base formed in a circular shape and a side wall provided in an outer circumferential surface of the base, and the heat radiating hole is provided along a circumferential direction of the base.

3. The washing machine as claimed in claim 2, wherein the blade is formed by bending the base after perforating the base, and the heat radiating hole is a space formed by the bent blade.

4. The washing machine as claimed in claim 3, wherein the heat radiating hole is formed by perforating the base one more time to allow the width of the blade larger than the width of the heat radiating hole.

5. The washing machine as claimed in claim 1, wherein a plurality of blades and a plurality of heat radiating holes are provided in the rotor, and
a formation direction of the blades is symmetrical with respect to a virtual central line passing a center of the base.

6. The washing machine as claimed in claim 1, wherein a plurality of blades and a plurality of heat radiating holes are provided in the rotor, and
a formation direction of the blades is symmetrical with respect to virtual first and second central lines which are perpendicular to each other, passing a center of the base.

7. The washing machine as claimed in claim 1, wherein a plurality of blades and a plurality of heat radiating holes are provided in the rotor, and
the blades are divided into a suction group configured to suck air into the rotor and an exhaustion group configured to exhaust air out of the rotor.

8. The washing machine as claimed in claim 7, wherein the suction group and the exhaustion group are reversed according to the rotation direction of the rotor.

9. The washing machine as claimed in claim 7, wherein the number of the heat radiating holes forming the suction group is identical to the number of the heat radiating holes forming the exhaustion group.
